(19) United States
(12) Patent Application Publication
(10) Pub. No.: US 2022/0134847 A1
(43) Pub. Date: May 5, 2022

(54) VENT APPARATUS

(71) Applicants: HYUNDAI MOTOR COMPANY, Seoul (KR); Kia Corporation, Seoul (KR)

(72) Inventors: Sang Shin LEE, Suwon-si (KR); Yoon Hyung LEE, Seongnam-si (KR)

(73) Assignees: HYUNDAI MOTOR COMPANY, Seoul (KR); Kia Corporation, Seoul (KR)

(21) Appl. No.: 17/392,757

(22) Filed: Aug. 3, 2021

(30) Foreign Application Priority Data
Oct. 30, 2020 (KR) 10-2020-0142609

(51) Int. Cl. B60H 1/34; B60H 1/00; B60H 1/24

(52) U.S. Cl. CPC B60H 1/3414; B60H 1/00664; B60H 2001/00721; B60H 1/00564; B60H 1/245

(57) ABSTRACT

The vent apparatus includes: a transfer duct located inside an upper surface of an interior of a vehicle; a vent located at a portion of the transfer duct; a variable guide located adjacent to the vent; and a driver located at a first end of the variable guide, and configured to apply a driving force to the variable guide and insert the variable guide into a trim, and to change a shape of the variable guide based on the driving force such that a direction of air discharged through the vent is controlled.

### CROSS-REFERENCE TO RELATED APPLICATION

This application claims priority to and the benefit of Korean Patent Application No. 10-2020-0142609, filed on Oct. 30, 2020, the entire contents of which are incorporated herein by reference.

### FIELD

The present disclosure relates to a vent apparatus. More particularly, it relates to a vent apparatus configured to control the direction of air discharged from a vent.

### BACKGROUND

The statements in this section merely provide background information related to the present disclosure and may not constitute prior art.

In general, an air conditioner system for vehicles includes a compressor configured to compress a refrigerant into a high pressure and discharge the high-pressure refrigerant, a condenser configured to condense the high-pressure refrigerant discharged from the compressor, an expansion unit configured to throttle the refrigerant liquefied and condensed by the condenser, and an evaporator configured to evaporate the low-pressure liquefied refrigerant throttled by the expansion unit through heat exchange with air blown to the interior of a vehicle so as to cool the air blown to the interior of the vehicle due to an endothermic reaction caused by evaporative latent heat of the refrigerant. The compressor, the condenser, the expansion unit and the evaporator are connected by refrigerant pipes.

The evaporator is installed within an air conditioner system case installed in the interior of the vehicle, and thus serves to cool the interior of the vehicle. That is, as air blown by an air blower passes through the evaporator, the air is cooled due to the evaporative latent heat of the liquefied refrigerant circulating inside the evaporator and is discharged to the interior of the vehicle to cool the interior of the vehicle.

Further, the interior of the vehicle is heated using a heater core, which is installed within the air conditioner system case such that engine cooling water is circulated in the heater core, or using an electric heater, which is installed within the air conditioner system case.

The condenser is installed in the front portion of the vehicle, and radiates heat while exchanging heat with air. Recently, a heat pump system, which performs heating and cooling using only a refrigeration cycle, has been developed.

In addition, a vent apparatus configured to discharge cold or warm air though the roof of a vehicle is used, and thus, technology that provides an air conditioner system to all seats of the vehicle has been applied now.

However, we have discovered that a vent apparatus located on the roof of a vehicle discharges cold or warm air through a small space, and further, a vent apparatus including a vent facing a wide area makes it difficult to employ a knob configured to adjust the direction of air discharged from the vent.

The above information disclosed in this Background section is only for enhancement of understanding of the background of the disclosure and therefore it may contain information that does not form the prior art that is already known to a person of ordinary skill in the art.

### SUMMARY

The present disclosure provides a vent apparatus, which adjusts the direction of air using the Coanda effect through change in the shape of a guidance part.

The present disclosure provides a vent apparatus, which is located in a narrow space so as to control the direction of air without adjusting a wing located in a vent.

In one aspect, the present disclosure provides a vent apparatus including a transfer duct located inside an upper surface of an interior of a vehicle, a vent located at a portion of the transfer duct, a variable guide located adjacent to the vent, and a driver located at one end of the variable guide and configured to apply a driving force to the variable guide and insert the variable guide into a trim and to change a shape of the variable guide based on the driving force such that a direction of air discharged through the vent is controlled.

In a preferred form, the variable guide may include a guidance part configured to extend along the vent, and a planar part configured to have one end inserted into the trim and to form a designated angle from one end of the guidance part.

In another preferred form, the end of the planar part may be inserted into the trim in response to the driving force of the driver, and the end of the guidance part may move from the vent along the planar part so that the shape of the guidance part is changed to a curved shape.

In still another preferred form, the variable guide may further include a gear unit located inside the planar part and configured to be connected to the driver.

In yet another preferred form, the vent apparatus may further include an impact absorber located between the guidance part and the transfer duct.

In still yet another preferred form, the vent may be configured to face a lower surface of the vehicle.

### DRAWINGS

In order that the disclosure may be well understood, there will now be described various forms thereof, given by way of example, reference being made to the accompanying drawings, in which:

FIG. 1 is a cross-sectional view of a vehicle to which a vent apparatus according to one form of the present disclosure is applied;

FIG. 2 is a schematic view illustrating coupling relationships in the vent apparatus according to one form of the present disclosure;

FIG. 3 is a view illustrating the vent apparatus according to one form of the present disclosure, which is operated in a dedicated sideways air direction mode;

FIG. 4 is a view illustrating the vent apparatus according to one form of the present disclosure, which is operated in a sideways and central air direction mode; and

FIG. 5 is a view illustrating the vent apparatus according to one form of the present disclosure, which is operated in a dedicated central air direction mode.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter reference will be made in detail to various forms of the present disclosure, examples of which are illustrated in the accompanying drawings and described below. While the disclosure will be described in conjunction with exemplary forms, it will be understood that the present description is not intended to limit the disclosure to the exemplary forms. On the contrary, the disclosure is intended to cover not only the exemplary forms, but also various alternatives, modifications, equivalents and other forms, which may fall within the spirit and scope of the present disclosure.

In the following description of the forms, it will be understood that the suffixes “part”, “unit”, “device”, etc. indicate units for processing at least one function or operation, and may be implemented using hardware, software, or a combination of hardware and software.

Further, the term ‘the upper surface of the interior of a vehicle’ in the following description of the forms conceptually encompasses a roof, the upper portion of a side trim, or the upper surface of a B-pillar of a vehicle, but the interior space of a vehicle, in which a vent apparatus according to the present disclosure is located, is not limited.

In addition, the term ‘a dedicated sideways air direction mode’ in the following description of the forms means the state in which the tip of a guidance part is adjusted to a position close to a side surface of the vehicle adjacent to the guidance part so that air discharged from the vent apparatus according to the present disclosure is discharged along the side surface of the vehicle, and the term ‘a dedicated central air direction mode’ in the following description of the forms means the state in which the tip of the guidance part is adjusted to a position close to the other side surface of the vehicle distant from the guidance part so that air discharged from the vent apparatus according to the present disclosure is discharged along the center of the vehicle.

Moreover, the term ‘a sideways and central air direction mode’ in the following description of the forms means the state in which the tip of the guidance part is adjusted so that air discharged from the vent apparatus according to the present disclosure is discharged along a space between the side surface and the center of the vehicle, and conceptually encompasses at least one air direction mode depending on the curvature shape of the guidance part.

However, the air direction mode may be changed depending on the fixed position of the vent apparatus onto the upper surface of the interior of the vehicle. Hereinafter, respective air direction modes of a vent apparatus including a vent located on the side surface of a vehicle according to one form of the present disclosure will be described, and the present disclosure is not limited to the relative discharge direction of air, which will be given in the following description of the forms.

Hereinafter reference will be made in detail to various forms of the present disclosure, examples of which are illustrated in the accompanying drawings and described below. In the following description of the forms, the same elements are denoted by the same reference numerals even when they are depicted in different drawings, and a detailed description thereof will thus be omitted.

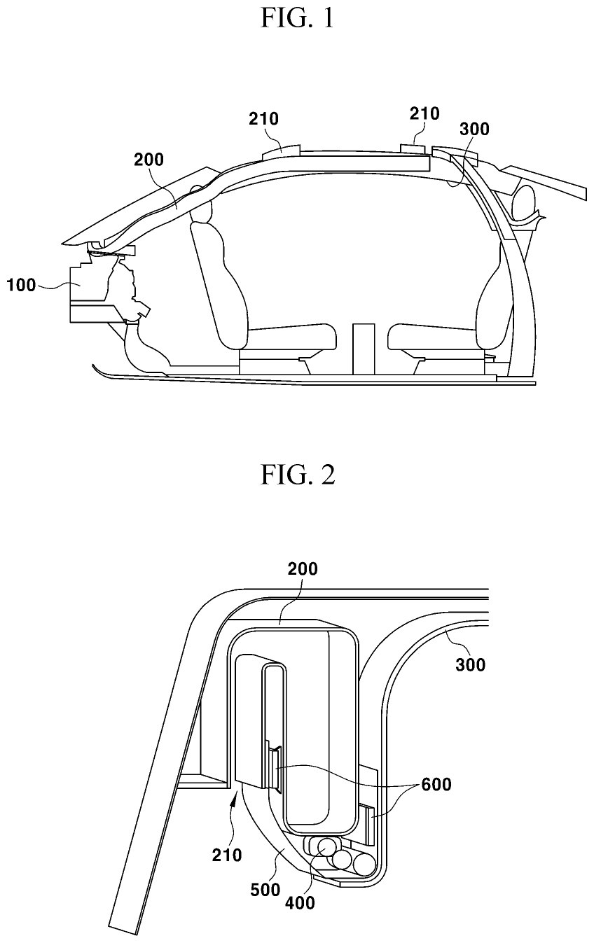

FIG. 1 is a cross-sectional view of a vehicle to which a vent apparatus according to one form of the present disclosure is applied.

Front defrost vents configured to discharge air to the front surfaces of front seats are provided on a dash panel of a vehicle, and side defrost vents configured to discharge cold air to defrost the side windows of the vehicle are disposed along the boundaries between side windows and the upper portions of the side surfaces of the vehicle.

The side defrost vents communicate with an air conditioner system 100 of the vehicle, pass through a front pillar, and extend towards the upper portions of the side windows of the vehicle. Further, a vent apparatus, which communicates with the air conditioner system 100 in the same manner as the side defrost vents, extends along the roof of the vehicle, and includes vents 210 configured to discharge cold or warm air to the interior of the vehicle from the top, may be additionally provided.

The vent apparatus is connected to the air conditioner system 100 through a transfer duct 200 that is configured to extend along the upper surface of the interior of the vehicle such that a fluid flows therebetween. Further, cold air or warm air introduced from the air conditioner system 100 is circulated along the transfer duct 200, and the vent apparatus is configured to discharge the cold air or the warm air introduced from the air conditioner system 100 to the interior of the vehicle through the vent 210 connected to the transfer duct 200 so as to communicate with the interior of the vehicle.

That is, the air conditioner system 100 for vehicles according to the present disclosure is provided in a front engine compartment or the dash panel of the vehicle, and includes at least one vent apparatus, which communicates with the air conditioner system 100, extends along the roof of the vehicle, and is disposed at a side of the upper surface of the interior of the vehicle or the roof of the vehicle so as to discharge air introduced from the air conditioner system 100.

Further, the vent apparatus may include the vent 210 provided on a trim 300 of the vehicle to discharge air to the interior of the vehicle.

Air discharged through the vent 210 may be controlled so as to proceed towards the center of the interior of the vehicle through a variable guide 500, and in one form of the present disclosure, three modes, i.e., a dedicated sideways air direction mode, a dedicated central air direction mode, and a sideways and central air direction mode, are executable.

The dedicated sideways air direction mode is an air direction mode in which the direction of air discharged from the vent 210 substantially corresponds to the height direction of the vehicle, and the dedicated central air direction mode is an air direction mode in which air discharged through the vent apparatus flows in the width direction of the vehicle. Further, the sideways and central air direction mode is executed so as to allow at least one air direction, and thus, the direction of air discharged through the vent apparatus may have a designated angle towards the interior of the vehicle from the height direction of the vehicle depending on the driving amount of a driver 400.

However, in FIG. 1, elements in a connection structure between the air conditioner system 100 and the transfer duct 200 may be omitted or added, and here, at least one transfer duct 200 fixed to a roof frame may be provided.

Hereinafter, the structure of the vent apparatus according to one form of the present disclosure, which is executed in the respective air direction modes and includes at least one transfer duct 200 located on both sides of the upper surface of the interior of the vehicle, will be described.

FIG. 2 is a schematic view illustrating the vent apparatus according to one form of the present disclosure.

The vent apparatus includes at least one transfer duct 200 disposed in the length direction of the roof, and the vent 210 located on the transfer duct 200 and connected to the interior space of the vehicle such that the fluid flows therebetween. At least one vent 210 may be formed along the length direction of the transfer duct 200, and the position thereof is not limited according to one form of the present disclosure, which will be described below.

In one form of the present disclosure, the transfer duct 200 is connected to the air conditioner system 100 such that the fluid flows therebetween, and is fixedly coupled to the roof frame within a trim 300. Further, the transfer duct 200 is disposed at both ends of the vehicle in the width direction so as to extend in the length direction. Further, the trim 300 is provided on the lower surface of the transfer duct 200 so as to inhibit exposure of the transfer duct 200.

The vent 210 is configured to be located at one end of the transfer duct 200, and the transfer duct 200 is connected to the interior space of the vehicle such that the fluid flows therebetween.

The variable guide 500 is configured to extend in the height direction from the vent 210. More particularly, one end of the variable guide 500 is coupled to one side surface of the vent 210, and the other end of the variable guide 500 is located inside the trim 300. The variable guide 500 may be configured such that the other end of the variable guide 500 comes into the trim 300 in response to the driving force of the driver 400 fixed to the transfer duct 200. Therefore, the variable guide 500 is configured such that the shape of the variable guide 500 is controlled by the driving amount of the driver 400 and thus controls the direction of air discharged from the vent 210.

The variable guide 500 coming into the trim 300 includes a gear unit 530, and the gear unit 530 is coupled to the driver 400 so as to apply the driving force of the driver 400 to the other end of the variable guide 500. Therefore, the variable guide 500 is moved to the inside of the trim 300, and has a designated curvature along the trim 300 based on the vent 210.

The variable guide 500 includes a guidance part 510 configured to extend along the vent 210, and a planar part 520 formed at a designated angle from one end of the guidance part 510 and provided with one end inserted into the trim 300. Therefore, the driving force of the driver 400 is applied to the planar part 520 located inside the trim 300, and the exposed region of the planar part 520 is additionally moved to the inside of the trim 300 by the driving force of the driver 400. The end of the guidance part 510 coupled to the planar part 520 is moved away from the vent 210 in the width direction in response to movement of the planar part 520, and the guidance part 510 is configured to have a curvature based on one side of the vent 210.

The end of the guidance part 510 is moved in the width direction of the vehicle in response to movement of the planar part 520, and the guidance part 510 may be formed of a material having elasticity. More particularly, the guidance part 510 may be formed of a thermoplastic elastomer (TPE).

As such, the guidance part 510 may be formed of a material, which may exhibit elasticity so as to correspond to movement of the planar part 520, and be coupled to one side surface of the vent 210, and thus, the driver 400 may be controlled such that air discharged from the vent 210 is deflected due to the curvature of the guidance part 510.

That is, because air discharged from the vent 210 shows the Coanda effect depending on the degree of the curvature of the guidance part 510 that is configured to extend from the vent 210, an air current discharged so as to be close to the guidance part 510 loses a movement speed due to the coefficient of viscosity of the surface of the guidance part 510, and air discharged from the vent 210 so as to be far away from the guidance part 510 in the width direction is deflected to a position close to the guidance part 510. Therefore, as the curvature of the guidance part 510 is increased, air discharged from the vent 210 is deflected more in the width direction of the vehicle.

The impact absorbers 600 may be located between the guidance part 510 and the transfer duct 200, and between the inner surface of the planar part 520 and the transfer duct 200 so as to relieve the impact between the variable guide 500 and the transfer duct 200.

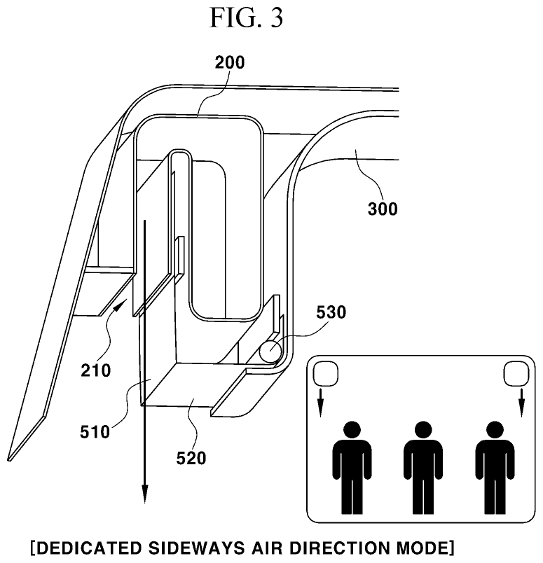

FIGS. 3 to 5 are views illustrating the respective air direction modes depending on the curvature of the guidance part 510.

FIG. 3 is a view illustrating the vent apparatus according to one form of the present disclosure, which is operated in the dedicated sideways air direction mode when the transfer duct 200 is located at the side of the upper surface of the interior of the vehicle.

According to one form of the present disclosure, the transfer duct 200 is disposed in the length direction of the vehicle and connected to the air conditioner system 100 such that the fluid flows therebetween, and here, at least one transfer duct 200 is located at each of both sides of the upper surface of the interior of the vehicle.

In the dedicated sideways air direction mode, the guidance part 510 extends in the same direction as the discharge direction of air from the vent 210 of the transfer duct 200 located at the side of the upper surface of the interior of the vehicle, and the planar part 520 is located parallel to the roof in the direction substantially orthogonal to the end of the guidance part 510 coupled to the planar part 520.

In this form of the present disclosure, the induction part 510 extends in the same direction as the discharge direction of air from the vent 210, and the other end of the planar part 520 is inserted into the trim 300 orthogonally to the end of the guidance part 510.

More particularly, in the dedicated sideways air direction mode, the vent apparatus may be set in an initial state in which the driving force of the driver 400 is not applied.

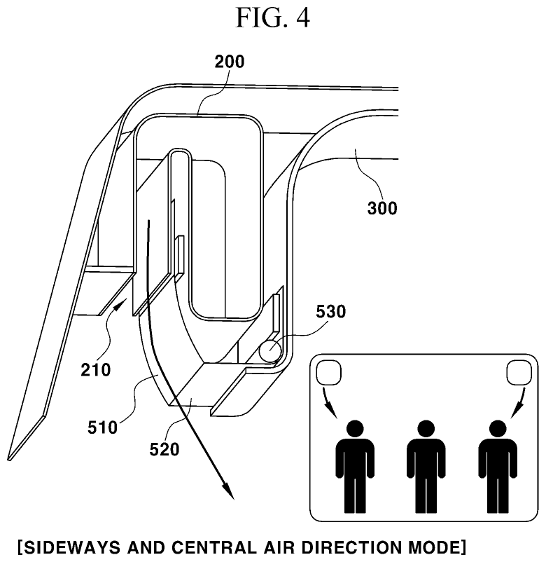

FIG. 4 is a view illustrating the vent apparatus according to one form of the present disclosure which is operated in the sideways and central air direction mode.

Compared to the dedicated sideways air direction mode, in the sideways and central air direction mode, the end of the guidance part 510 coupled to the planar part 520 is moved to a position close to the trim 300 together with movement of the planar part 520 but the other end of the guidance part 510 is fixed to the vent 210, and thus, the end of the guidance part 510 coupled to the planar part 520 is curved.

Further, the planar part 520 is moved to the inside of the trim 300 by the driving force of the driver 400, and in more detail, the driving force of the driver 400 is applied to the gear unit 530 coupled to the driver 400, and the planar part 520 and the gear unit 530 are integrally moved to the inside of the trim 300 by the driving force applied to the gear unit 530.

One end of the guidance part 510 is coupled to one end of the planar part 520, and thus, the end, i.e., the lower end, of the guidance part 510 is moved to a position close to the trim 300 in response to movement of the planar part 520. In the sideways and central air direction mode in which the end of the guidance part is moved so as to have a designated curvature, air discharged through the vent 210 is set to flow in a designated direction along the guidance part 510 based on the Coanda effect.

Compared to the guidance part 510 disposed in the vertical direction, through the guidance part 510 disposed to have the curvature, the amount of air discharged to the central region of the interior of the vehicle is increased and thus air is supplied to both the side surface and the central region of the interior of the vehicle.

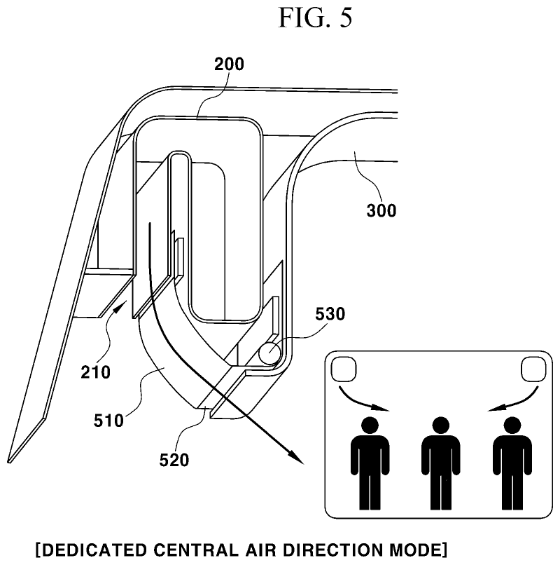

FIG. 5 is a view illustrating the vent apparatus according to one form of the present disclosure, which is operated in the dedicated central air direction mode.

In the dedicated central air direction mode, the end of the guidance part 510 coupled to one end of the planar part 520 is moved to the position closest to the trim 300 into which the planar part 520 comes, and thus the side surface of the guidance part 510 has the maximum curvature. The driver 400 is configured to be coupled to the gear unit 530 located inside the planar part 520 so as to apply driving force to additionally insert the gear unit 530 and the planar part 520 integrally into the trim 300. The planar part 520, to which the driving force is applied, is configured to be moved integrally with the end of the guidance part 510.

In one form of the present disclosure, the planar part 520 is moved in the horizontal direction along the trim 300, and the end of the guidance part 510 is moved away from the vent 210.

Here, the driver 400 is driven so that the guidance part 510 has the maximum curvature, and thus, air discharged to the interior of the vehicle through the vent 210 is discharged in a direction along the surface of the guidance part 510. That is, air flowing along the surface of the guidance part 510 has a lower speed than the speed of air flowing so as to be far away from the surface of the guidance part 510, and thus, air is discharged towards the central region of the interior of the vehicle from the vent 210 located at the side of the upper surface of the vehicle.

The present disclosure provides the vent apparatus located at both sides of the upper surface of the interior of the vehicle, and the vent apparatus is configured such that, when the end of the guidance part 510 is moved to the position closest to the central portion of the vehicle, air is discharged from each vent 210 toward the center of the interior of the vehicle.

In summary, the present disclosure provides the vent apparatus configured such that the shape of the variable guide 500 is changed and the radius of curvature of the guidance part 510 is changed depending on the driving force of the driver 400, so as to adjust the direction of air discharged from the vent apparatus without any separate wing structure.

As is apparent from the above description, the present disclosure may have the following effects due to the above-described configuration and coupling and using relationships in the above-described forms.

The present disclosure provides a vent apparatus, which may adjust the direction of air through a simple structure of a guidance part configured to extend along a vent, thereby providing structural simplification.

Further, the vent apparatus according to the present disclosure provides the vent without any separate structure, thereby increasing structural rigidity.

The disclosure has been described in detail with reference to preferred forms thereof. However, it will be appreciated by those skilled in the art that changes may be made in these forms without departing from the principles and spirit of the present disclosure.

What is claimed is:

1. A vent apparatus comprising:
a transfer duct located inside an upper surface of an interior of a vehicle;
a vent located at a portion of the transfer duct;
a variable guide located adjacent to the vent; and
a driver located at a first end of the variable guide, and configured to:
apply a driving force to the variable guide and insert the variable guide into a trim, and
change a shape of the variable guide based on the driving force such that a direction of air discharged through the vent is controlled.

2. The vent apparatus of claim 1, wherein the variable guide comprises:
a guidance part configured to extend along the vent; and
a planar part including a first end inserted into the trim and configured to form a designated angle from a first end of the guidance part.

3. The vent apparatus of claim 2, wherein the first end of the planar part is inserted into the trim in response to the driving force of the driver, and the first end of the guidance part moves along the planar part from the vent so that a shape of the guidance part is changed to a curved shape.

4. The vent apparatus of claim 2, wherein the variable guide further comprises a gear unit located inside the planar part and configured to be connected to the driver.

5. The vent apparatus of claim 1, further comprising: an impact absorber located between the guidance part and the transfer duct.

6. The vent apparatus of claim 1, wherein the vent faces a lower surface of the vehicle.
